(19) United States
(12) Patent Application Publication
(10) Pub. No.: US 2009/0029666 A1
(43) Pub. Date: Jan. 29, 2009

(54) NOISE CANCELLATION METHOD, RECEIVER CIRCUIT, AND ELECTRONIC INSTRUMENT

(75) Inventor: Kazumi MATSUMOTO, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/171,684

(22) Filed: Jul. 11, 2008

(30) Foreign Application Priority Data
Jul. 24, 2007 (JP) 2007-192234

(51) Int. Cl. H04B 1/10; H04B 1/16

(52) U.S. Cl. 455/234.1; 455/308; 375/345

(57) ABSTRACT

A noise cancellation method includes: inputting an interference wave signal detected near a receiver, and changing the phase and the amplitude of the input signal to generate a cancellation signal that cancels the input signal; adding the cancellation signal to a received signal received by the receiver, amplifying the resulting signal by a given amplification factor, and converting the amplified signal into a digital signal; controlling the amplification factor based on a frequency ratio of each signal value of the digital signal; and controlling amounts by which the phase and the amplitude of the input signal are changed, based on the amplification factor.

Japanese Patent Application No. 2007-192234 filed on Jul. 24, 2007, is hereby incorporated by reference in its entirety.

### BACKGROUND

The present invention relates to a noise cancellation method, a receiver circuit, and an electronic instrument including the receiver circuit.

A phenomenon referred to as crosstalk in which a signal transmitted through one channel is superimposed on another channel has been known. Since crosstalk causes a significant deterioration in signal quality, various technologies have been proposed to prevent crosstalk or remove a mixed crosstalk component. For example, technology that removes a crosstalk component by generating a signal (cancellation signal) that cancels (attenuates or removes) a mixed crosstalk component (see U.S. Pat. No. 7,050,388) has been developed.

In an electronic instrument including a receiver circuit, an alternating current signal may be generated due to a change in electromagnetic field caused by the circuit operation of an electronic circuit disposed near the receiver circuit. The alternating current signal may be transmitted to the receiver circuit and mixed into the received signal as an interference wave. Noise cancellation technology that cancels the interference wave superimposed on the received signal by generating a cancellation signal and adding the cancellation signal to the received signal has been known.

However, noise may not be appropriately cancelled using this noise cancellation technology. Specifically, an interference wave may not be accurately detected (e.g., only part of the interference signal is detected, or the interference signal is detected in a state in which part of the reception target signal is mixed with the interference signal). In this case, the mixed interference wave may be removed to only a small extent, or the reception target signal may be partially attenuated.

### SUMMARY

According to one aspect of the invention, there is provided a noise cancellation method comprising:

inputting an interference wave signal detected near a receiver, and changing the phase and the amplitude of the input signal to generate a cancellation signal that cancels the input signal;

adding the cancellation signal to a received signal received by the receiver, amplifying the resulting signal by a given amplification factor, and converting the amplified signal into a digital signal;

controlling the amplification factor based on a frequency ratio of each signal value of the digital signal; and

controlling amounts by which the phase and the amplitude of the input signal are changed, based on the amplification factor.

### BRIEF DESCRIPTION OF THE DRAWINGS

FIG. 1 is a view showing the internal configuration of a portable telephone.

FIG. 2 is a view showing the A/D conversion principle of an A/D converter.

FIG. 3 is a view showing the gain with respect to the phase/amplitude of a cancellation signal.

FIG. 4 is a flowchart showing a cancellation signal generation control process.

FIG. 5 is a flowchart of a phase shift amount/attenuation factor change process executed during the cancellation signal generation control process.

FIG. 6 is a view showing the internal configuration of a portable telephone including an AGC circuit.

FIG. 7 is a view showing the internal configuration of a portable telephone which does not include an interference wave detection section.

### DESCRIPTION OF EXEMPLARY EMBODIMENTS

The invention may implement reliable noise cancellation.

One embodiment of the invention relates to a receiver circuit comprising: a cancellation signal generator, a signal that indicates an interference wave detected near a receiver or an interference signal being input to the cancellation signal generator, the cancellation signal generator changing the phase and the amplitude of the input signal by a given phase shift amount and a given amplitude change rate to generate a cancellation signal that cancels the input signal; an addition section that adds the cancellation signal to a received signal received by the receiver; an amplifier that amplifies the signal obtained by the addition section by a given amplification factor; an A/D converter that converts the amplified signal into a digital signal; an automatic gain controller (AGC) that changes the amplification factor of the amplifier so that a frequency ratio of each signal value of the digital signal satisfies a given ratio condition; and a cancellation signal generation controller that variably controls a phase shift amount and an amplitude change rate of the cancellation signal generator based on the amplification factor changed by the AGC.

Another embodiment of the invention relates to a noise cancellation method that cancels a noise component included in a received signal received by a receiver of a receiver circuit, the receiver circuit including an amplifier that amplifies the received signal by a given amplification factor, an A/D converter that converts the amplified signal into a digital signal, and an automatic gain controller (AGC) that changes the amplification factor of the amplifier so that a frequency ratio of each signal value of the digital signal satisfies a given ratio condition, the method comprising: inputting a signal that indicates an interference wave detected near the receiver or an interference signal, and changing the phase and the amplitude of the input signal by a given phase shift amount and a given amplitude change rate to generate a cancellation signal that cancels the input signal; adding the cancellation signal to the received signal received by the receiver; causing the amplifier to amplify the received signal, to which the cancellation signal has been added, by the given amplification factor; and variably controlling the phase shift amount and the amplitude change rate used when generating the cancellation signal based on the amplification factor changed by the AGC.

According to the above configuration, a noise component included in the received signal is canceled by adding the cancellation signal to the received signal, and the phase shift amount and the amplitude change rate used when generating the cancellation signal are changed based on the amplification factor of the amplifier that amplifies the signal obtained by adding the cancellation signal to the received signal. The degree of noise removal due to the addition of the cancellation signal differs corresponding to the phase or amplitude of the cancellation signal. The level of the signal obtained by adding the cancellation signal to the received signal differs corresponding to the degree of noise removal. The amplification factor of the amplifier is changed so that the frequency ratio of each signal value of the digital signal converted by the A/D converter satisfies the given ratio condition. The frequency ratio of each signal value differs corresponding to the level of the signal before being converted by the A/D converter (i.e., the signal amplified by the amplifier). Specifically, the AGC changes the amplification factor of the amplifier so that the level of the amplified signal is constant. The degree of noise removal due to the cancellation signal differs depending on the difference in phase or amplitude of the cancellation signal. As a result, the amplification factor of the amplifier differs depending on the difference in phase or amplitude of the cancellation signal. Therefore, a cancellation signal appropriate for removing noise included in the received signal is generated by changing the phase shift amount and the amplitude change rate used when generating the cancellation signal based on the amplification factor of the amplifier, whereby appropriate noise cancellation is implemented.

In the above receiver circuit, the cancellation signal generation controller may perform a search process that searches for a phase shift amount and an amplitude change rate that maximize the amplification factor changed by the AGC while changing the phase shift amount and the amplitude change rate of the cancellation signal generator as the phase shift amount and the amplitude change rate of the cancellation signal generator.

According to the above configuration, the search process that searches for a phase shift amount and an amplitude change rate that maximize the amplification factor of the amplifier while changing the phase shift amount and the amplitude change rate of the cancellation signal as the phase shift amount and the amplitude change rate of the cancellation signal generator is performed when generating the cancellation signal.

In the above receiver circuit, the cancellation signal generation controller may set an amplification factor change allowable range including an amplification factor that equals the amplification factor when the amplification factor changed by the AGC has become a maximum during the search process, and may perform an adjustment process that adjusts the phase shift amount and the amplitude change rate of the cancellation signal generator so that the amplification factor changed by the AGC is included within the amplification factor change allowable range after the search process.

According to the above configuration, after the search process, the adjustment process is performed that adjusts the phase shift amount and the amplitude change rate so that an amplification factor that equals the amplification factor changed by the search process is included within the amplification factor change allowable range.

In the above receiver circuit, the cancellation signal generation controller may reset the amplification factor change allowable range based on the amplification factor changed by the AGC during the adjustment process.

According to the above configuration, the amplification factor change allowable range is reset based on the amplification factor of the amplifier changed during the adjustment process. Therefore, even if the optimum amplification factor changes due to a change in noise included in the received signal, more appropriate noise cancellation can be ensured by resetting the amplification factor change allowable range.

In the above receiver circuit, the phase shift amount and the amplitude change rate of the cancellation signal generator may be changed by the cancellation signal generation controller in the adjustment process by amounts smaller than those of the search process.

According to the above configuration, the phase shift amount and the amplitude change rate of the cancellation signal are changed in the adjustment process by amounts smaller than those of the search process.

In the above receiver circuit, the receiver may receive a positioning satellite signal from a positioning satellite, and the receiver circuit may include a positioning calculator that calculates a present position based on the digital signal converted by the A/D converter.

According to the above configuration, the above receiver circuit may be applied to a GPS receiver circuit that receives a GPS satellite signal from a GPS satellite as the positioning satellite signal from the positioning satellite, and calculate the present position, for example.

A further embodiment of the invention relates to an electronic instrument comprising the above receiver circuit.

Preferred embodiments of the invention are described below with reference to the drawings. The following description is given taking an example in which the invention is applied to a portable telephone having a GPS function. Note that embodiments to which the invention may be applied are not limited thereto.

Configuration of Portable Telephone

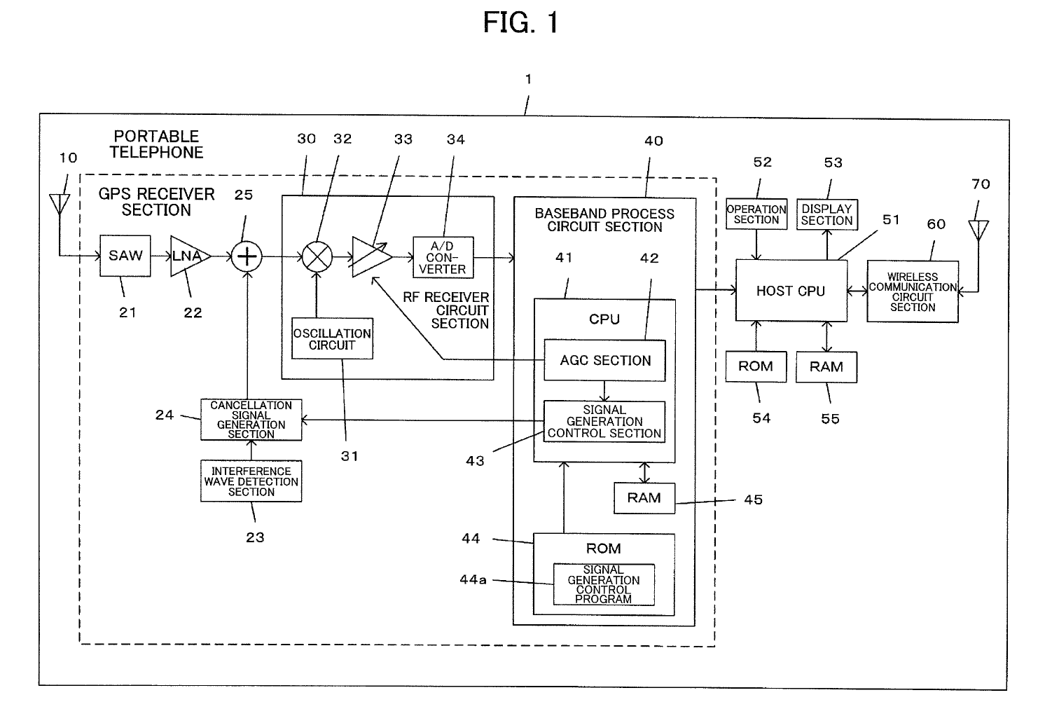

FIG. 1 is a block diagram showing an example of the internal configuration of a portable telephone 1 according to one embodiment of the invention. As shown in FIG. 1, the portable telephone 1 has a GPS function, and includes a GPS antenna 10, a GPS receiver section (i.e., receiver circuit) 20, a host central processing unit (CPU) 51, an operation section 52, a display section 53, a read-only memory (ROM) 54, a random access memory (RAM) 55, a wireless communication circuit section 60, and an antenna 70.

The GPS antenna 10 is an antenna that receives an RF signal including a GPS satellite signal transmitted from a GPS satellite.

The GPS receiver section 20 extracts the GPS satellite signal from the RF signal received by the GPS antenna 10, and calculates the present position of the portable telephone 1 by performing positioning calculations based on a navigation message extracted from the GPS satellite signal and the like. The GPS receiver section 20 includes a surface acoustic wave (SAW) filter 21, a low-noise amplifier (LNA) 22, an interference wave detection section 23, a cancellation signal generation section 24, an adder 25, a radio frequency (RF) receiver circuit section 30, and a baseband process circuit section 40. The RF receiver circuit section 30 and the baseband process circuit section 40 of the GPS receiver section 20 may be produced as different large scale integrated (LSI) circuits, or may be produced in one chip. The entire GPS receiver section 20 including the SAW filter 21, the LNA 22, and the like may be produced in one chip.

The SAW filter 21 is a bandpass filter. The SAW filter 21 allows a given band signal of the RF signal input from the GPS antenna 10 to pass through while blocking a frequency component outside the given band, and outputs the resulting signal. The LNA (low-noise amplifier) 22 amplifies the signal input from the SAW filter 21, and outputs the amplified signal.

The interference wave detection section 23 detects an interference wave (noise) superimposed on the signal received by the GPS antenna 10. The interference wave detection section 23 includes a pickup coil or the like that detects a change in electromagnetic field near the GPS antenna 10 and the GPS receiver section 20 (i.e., receiver section), and outputs the detected change in electromagnetic field as an interference signal. Note that the interference signal detection section 23 may be provided at an arbitrary position outside the GPS receiver section 20 instead of disposing the interference signal detection section 23 in the GPS receiver section 20, and may be connected to the GPS receiver section 20 via interconnects such as signal lines. The interference signal detection section 23 detects noise (i.e., a change in electromagnetic field) superimposed on the received signal. The detection target of a change in electromagnetic field may be an arbitrary electronic circuit. For example, the detection target may be a portable telephone or wireless LAN communication circuit, a processor such as a CPU, a circuit provided in a liquid crystal display device, or the like. Since it is necessary to detect a change in electromagnetic field that serves as an interference wave for the received signal, it is desirable that the detection target be an electronic circuit positioned near the GPS antenna 10 or the GPS receiver section 20.

The cancellation signal generation section 24 generates a cancellation signal for removing an interference wave superimposed on the received signal. Specifically, the cancellation signal generation section 24 generates the cancellation signal by shifting the phase of a signal, obtained by shifting the phase of the interference signal detected by the interference wave detection section 23 by 180 degrees, by a phase shift amount φ while attenuating the signal by an attenuation factor α (amplitude change rate), based on a cancellation control signal input from a signal generation control section 43.

The adder 25 adds the cancellation signal generated by the cancellation signal generation section 24 to the signal amplified by the LNA 22.

The RF receiver circuit section 30 down-converts the signal (RF signal) input from the adder 25 into an intermediate-frequency (IF) signal, converts the IF signal into a digital signal, and outputs the resulting digital signal. The RF receiver circuit section 30 includes an oscillation circuit 31, a mixer 32, an amplifier 33, and an A/D converter 34.

The oscillation circuit 31 is a crystal oscillator or the like, and generates a local oscillation signal having a given oscillation frequency. The mixer 32 multiplies the RF signal input from the adder 25 by the local oscillation signal input from the oscillation circuit 31 (i.e., synthesizes the RF signal and the local oscillation signal) to generate an IF signal. The amplifier 33 is a variable amplifier that amplifies the IF signal generated by the mixer 32 while changing the amplification factor based on a gain control signal input from an AGC section 42.

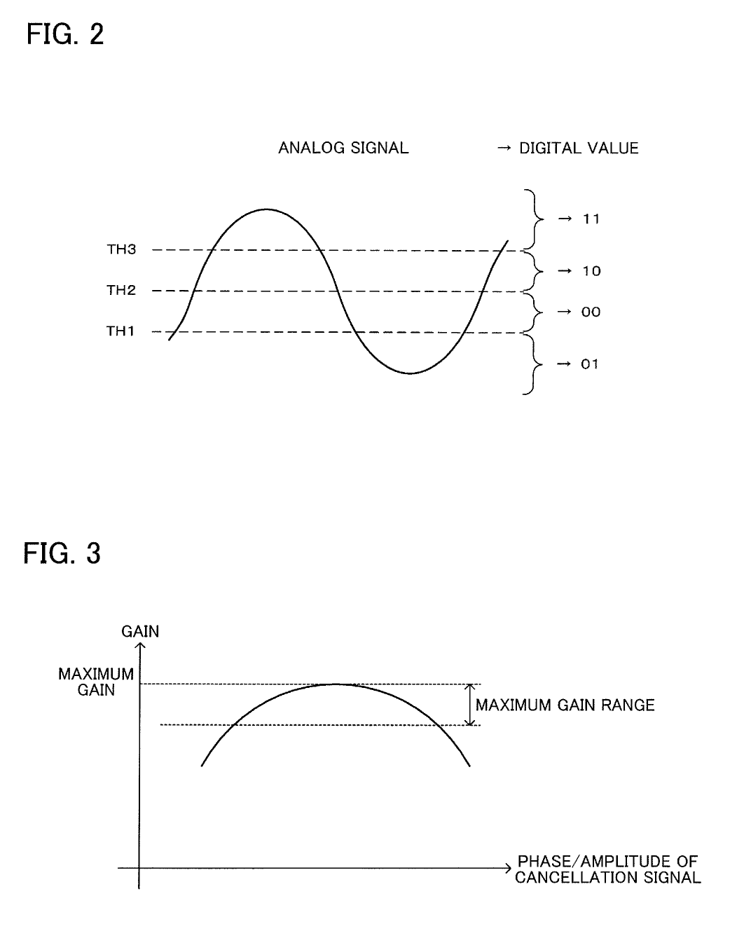

The A/D converter 34 converts the IF signal amplified by the amplifier 33 into a multi-bit (two bits or more) digital signal. FIG. 2 is a view showing the A/D conversion principle of the A/D converter 34. FIG. 2 shows two-bit conversion. In this case, three threshold values TH1 to TH3 (TH1<TH2<TH3) are provided, and the IF signal is converted into a two-bit digital signal (i.e., “00”, “01”, “10”, or “11”) corresponding to the threshold values TH between which the level of the conversion-target analog signal is positioned.

Again referring to FIG. 2, the baseband process circuit section 40 acquires/tracks the GPS satellite signal from the IF signal input from the RF receiver circuit section 30, and performs pseudo-range calculations, positioning calculations, and the like based on a navigation message, time information, and the like extracted by decoding the data contained in the GPS satellite signal. The baseband process circuit section 40 includes a CPU 41, a ROM 44, a RAM 45, a code replica generation circuit, a correlation calculation circuit that performs correlation calculations, a data decoder circuit, and the like.

The CPU 41 includes the AGC section 42 and the signal generation control section 43. The CPU 41 controls each section of the baseband process circuit section 40, and performs various calculation processes including a baseband process. In the baseband process, the CPU 41 acquires/tracks the GPS satellite signal based on the IF signal input from the RF receiver circuit section 30. The CPU 41 acquires the GPS satellite signal by extracting the GPS satellite signal from the IF signal by performing a correlation process on the IF signal. Specifically, the CPU 41 performs a coherent process that calculates the correlation between the IF signal and a pseudo-generated code replica using FFT calculations, and an incoherent process that calculates the integrated correlation value by integrating the correlation values (i.e., coherent process results). As a result, the phases of a C/A code and a carrier frequency contained in the GPS satellite signal are obtained.

The CPU 41 tracks the GPS satellite signals by synchronously holding the acquired GPS satellite signals in parallel. For example, the CPU 41 performs a code loop which is implemented by a delay locked loop (DLL) and tracks the phase of the C/A code, and a carrier loop which is implemented by a phase locked loop (PLL) and tracks the phase of the carrier frequency. The CPU 41 decodes the data contained in the tracked GPS satellite signal to extract the navigation message, and performs pseudo-range calculations, positioning calculations, and the like to locate the present position.

The AGC section 42 controls the amplification factor of the amplifier 33 based on the IF signal input from the RF receiver circuit section 30. Specifically, the AGC section 42 controls the amplification factor of the amplifier 33 so that the ratio of the signal value of each digital signal converted by the A/D converter 34 satisfies a given ratio condition to control the level of the input analog signal. The ratio condition is a condition whereby the conversion efficiency of the A/D converter 34 becomes a maximum. For example, when using two-bit conversion shown in FIG. 2, each of the four converted signal values “10”, “00”, “11”, and “01” occurs in an equal ratio.

The received signal received by the GPS antenna 10 is a signal in which an interference wave (noise) is mixed into (superimposed on) the GPS satellite signal that is the reception target signal. Specifically, the level of the received signal is higher than the level of the GPS satellite signal by the level of the interference wave mixed into the received signal. The level of the interference wave changes corresponding to the degree of mixing. Specifically, the AGC section 42 controls the amplification factor of the amplifier 33 so that the gain decreases as the level of the interference wave mixed into the received signal increases.

The signal generation control section 43 generates the cancellation control signal that controls the phase shift amount φ and the attenuation factor α used when the cancellation signal generation section 24 generates the cancellation signal based on the gain calculated by the AGC section 42. FIG. 3 is a view showing the gain with respect to the phase or amplitude of the cancellation signal. The degree of removal of the interference wave mixed into the received signal differs corresponding to the phase or amplitude of the cancellation signal. As described above, the AGC section 42 controls the amplification factor of the amplifier 33 so that the gain decreases as the level of the interference wave mixed into the received signal increases. Specifically, the gain decreases as the interference wave is mixed into the received signal to a larger extent. Specifically, the gain changes corresponding to the phase or amplitude of the cancellation signal, and becomes a maximum when the interference wave has been removed to the maximum extent, as shown in FIG. 3. Therefore, the signal generation control section 43 controls the phase shift amount φ and the attenuation factor α used when the cancellation signal generation section 24 generates the cancellation signal so that the gain becomes a maximum.

Specifically, the signal generation control section 43 searches for the maximum gain. Specifically, the signal generation control section 44 searches for the phase shift amount φ that maximizes the gain by increasing or decreasing the phase shift amount φ by a given phase shift change amount Δφ1 while setting the attenuation factor α at a constant value. When the signal generation control section 43 has determined the phase shift amount φ that maximizes the gain, the signal generation control section 43 searches for the attenuation factor α that maximizes the gain by increasing or decreasing the attenuation factor α by a given attenuation factor change amount Δα1 while setting the phase shift amount φ at the determined value.

When the signal generation control section 43 has determined the attenuation factor α that maximizes the gain, the signal generation control section 43 determines the gain at the determined attenuation factor α to be the maximum gain. The signal generation control section 43 determines a given range around the maximum gain to be a maximum gain range (amplification factor change allowable range). In this case, the determined maximum gain does not necessarily coincide with the true maximum gain. This is because the phase shift amount φ and the attenuation factor α are changed by the phase shift change amount Δφ and the attenuation factor change amount Δα, respectively. Therefore, a given range around the maximum gain is set to be the maximum gain range.

The signal generation control section 43 then adjusts the phase shift amount φ and the attenuation factor α so that the gain is included within the maximum gain range. Specifically, when the present gain is included within the maximum gain range, the signal generation control section 43 maintain the present phase shift amount φ and the present attenuation factor α. When the present gain is outside the maximum gain range, the signal generation control section 43 changes the phase shift amount φ and the attenuation factor α so that the gain is included within the maximum gain range. Specifically, the signal generation control section 43 searches for the phase shift amount φ and the attenuation factor α that maximize the gain by changing one of the phase shift amount φ and the attenuation factor α while fixing the other of the phase shift amount φ and the attenuation factor α. The signal generation control section 43 determines the resulting gain to be a new maximum gain, and resets the maximum gain range. In this case, the phase shift amount φ and the attenuation factor α are changed by a given phase shift change amount Δφ2 and a given attenuation factor change amount Δα2, respectively. The phase shift change amount Δφ2 and the attenuation factor change amount Δα2 are set to be smaller than the phase shift change amount Δφ1 and the attenuation factor change amount Δα1 used when searching for the maximum gain.

The ROM 44 stores a system program that causes the CPU 41 to control each section of the baseband process circuit section 40 and the RF receiver circuit section 30, a program and data necessary for the CPU 41 to implement various processes including the baseband process, a signal generation control program 44a for implementing a cancellation signal generation control process performed by the signal generation control section 43, and the like.

The RAM 45 is used as a work area for the CPU 41, and temporarily stores a program and data read from the ROM 44, the calculation results of the CPU 41 based on various programs, and the like.

The host CPU 51 controls each section of the portable telephone 1 based on various programs such as a system program stored in the ROM 54. Specifically, the host CPU 51 mainly implements a telephone call function, and also performs a process that implements various functions including a navigation function such as causing the display section 53 to display a navigation screen in which the present position of the portable telephone 1 input from the baseband process circuit section 40 is plotted on a map.

The operation section 52 is an input device including an operation key, a button switch, and the like. The operation section 52 outputs an operation signal corresponding to the operation of the user to the host CPU 51. Various instructions such as a positioning start/finish instruction are input by operating the operation section 52. The display section 53 is a display device such as a liquid crystal display (LCD). The display section 53 displays a display screen (e.g., navigation screen and time information) based on a display signal input from the host CPU 51.

The ROM 54 stores a system program that causes the host CPU 51 to control the portable telephone 1, a program and data necessary for implementing the navigation function, and the like. The RAM 55 is used as a work area for the host CPU 51. The RAM 55 temporarily stores a program and data read from the ROM 54, data input from the operation section 52, calculation results of the host CPU 51 based on various programs, and the like.

The wireless communication circuit section 60 is a portable telephone communication circuit section that includes an RF conversion circuit, a baseband process circuit, and the like, and transmits and receives a radio signal under control of the host CPU 51. The antenna 70 is an antenna that transmits and receives a portable telephone radio signal between the portable telephone 1 and a radio base station installed by a communication service provider of the portable telephone 1. Note that other circuits such as the wireless communication circuit section 60 utilize a reference signal REF generated by the oscillation circuit 31 (not shown).

Process Flow

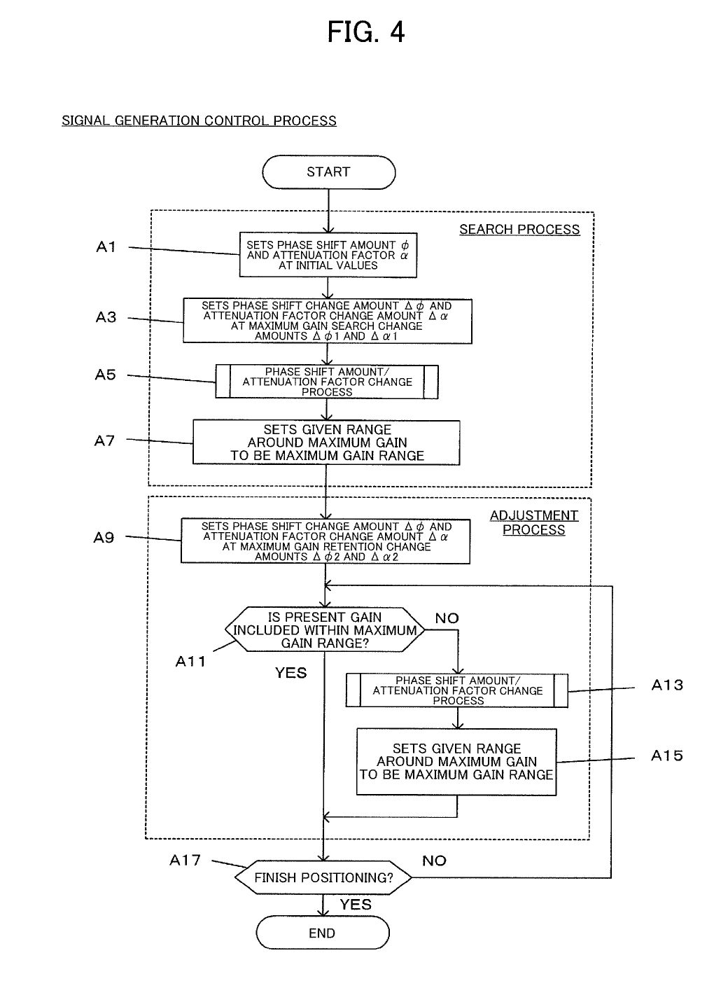

FIG. 4 is a flowchart illustrative of the signal generation control process performed by the signal generation control section 43. As shown in FIG. 4, the signal generation control section 43 performs a search process that searches for the maximum gain. Specifically, the signal generation control section 43 sets the phase shift amount φ and the attenuation factor α at predetermined initial values (step A1). The signal generation control section 43 sets the phase shift change amount Δφ and the attenuation factor change amount Δα at the maximum gain search change amounts Δφ1 and Δα1, respectively (step A3). The signal generation control section 43 then performs a phase shift amount/attenuation factor change process. Specifically, the signal generation control section 43 searches for the maximum gain while changing the phase shift amount φ and the attenuation factor α of the cancellation signal (step A5).

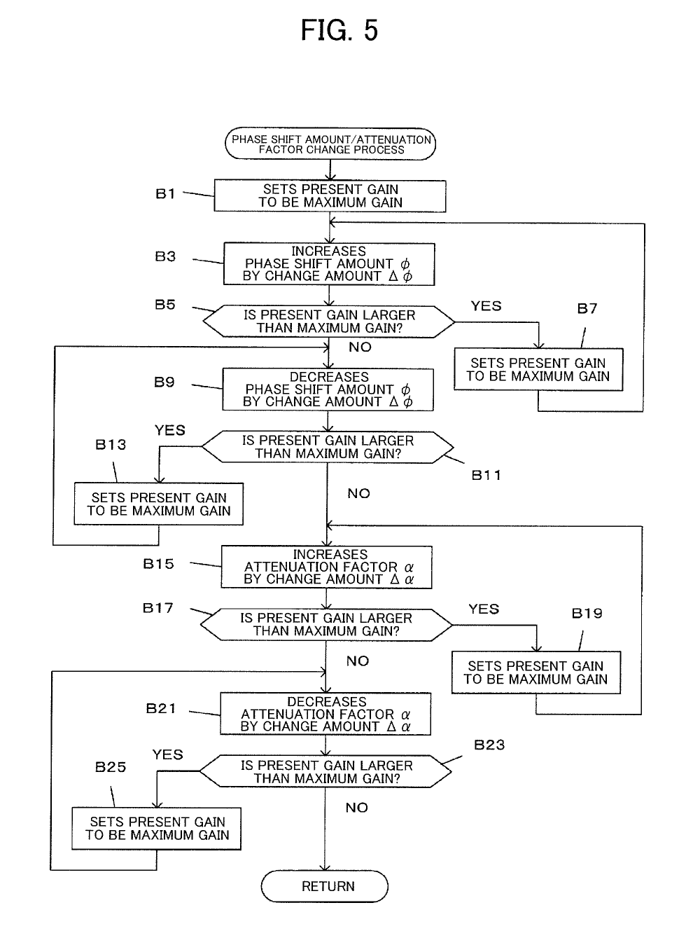

FIG. 5 is a flowchart illustrative of the flow of the phase shift amount/attenuation factor change process. As shown in FIG. 5, the signal generation control section 43 sets the present gain to be the maximum gain (step B1). The signal generation control section 43 increases the phase shift amount φ by the phase shift change amount Δφ without changing the attenuation factor α (step B3). When the present gain exceeds the maximum gain (step B5: YES), the signal generation control section 43 sets the present gain to be the maximum gain (step B7). The signal generation control section 43 then returns to the step B3, and repeats a similar process while further increasing the phase shift amount φ. When the present gain has become equal to or less than the maximum gain as a result of increasing the phase shift amount φ (step B5: NO), the signal generation control section 43 decreases the phase shift amount φ by the phase shift change amount Δφ (step B9). When the present gain exceeds the maximum gain (step B11: YES), the signal generation control section 43 sets the present gain to be the maximum gain (step B13). The signal generation control section 43 then returns to the step B9, and repeats a similar process while further decreasing the phase shift amount φ.

When the present gain has become equal to or less than the maximum gain as a result of decreasing the phase shift amount φ (step B11: NO), the signal generation control section 43 increases the attenuation factor α by the attenuation factor change amount Δα without changing the phase shift amount φ (step B15). When the present gain exceeds the maximum gain (step B17: YES), the signal generation control section 43 sets the present gain to be the maximum gain (step B19). The signal generation control section 43 then returns to the step B15, and repeats a similar process while further increasing the attenuation factor α. When the present gain has become equal to or less than the maximum gain as a result of increasing the attenuation factor α (step B17: NO), the signal generation control section 43 decreases the attenuation factor α by the attenuation factor change amount Δα (step B21). When the present gain exceeds the maximum gain (step B23: YES), the signal generation control section 43 sets the present gain to be the maximum gain (step B25). The signal generation control section 43 then returns to the step B21, and repeats a similar process while further decreasing the attenuation factor α. When the present gain has become equal to or less than the maximum gain as a result of decreasing the attenuation factor α (step B23: NO), the signal generation control section 43 finishes the phase shift amount/attenuation factor change process.

When the phase shift amount/attenuation factor change process has been completed, the signal generation control section 43 sets a given range around the maximum gain set by the phase shift amount/attenuation factor change process to be the maximum gain range (step A7). The search process is thus completed.

When the search process has been completed, the signal generation control section 43 performs an adjustment process that adjusts the cancellation signal so that the maximum gain is retained. Specifically, the signal generation control section 43 sets the phase shift change amount Δφ and the attenuation factor change amount Δα at the maximum gain retention change amounts Δφ2 and Δα2, respectively (step A3). The signal generation control section 43 determines whether or not the present gain input from the AGC section 42 is included within the maximum gain range. When the present gain is outside the maximum gain range (step A11: NO), the signal generation control section 43 again performs the phase shift amount/attenuation factor change process (see FIG. 5). Specifically, the signal generation control section 43 searches for the maximum gain while changing the phase shift amount φ and the attenuation factor α of the cancellation signal (step A13). When the phase shift amount/attenuation factor change process has been completed, the signal generation control section 43 sets a given range around the maximum gain set by the phase shift amount/attenuation factor change process to be the maximum gain range (step A15). The adjustment process is thus completed.

When the adjustment process has been completed, the signal generation control section 43 determines whether or not to finish positioning. When the signal generation control section 43 has determined to continue positioning (step A17: NO), the signal generation control section 43 returns to the step A11. When the signal generation control section 43 has determined to finish positioning (step A17: YES), the signal generation control section 43 finishes the cancellation signal control process.

Effects

According to this embodiment, the signal generation control section 43 provided in the portable telephone 1 having a GPS function controls generation of the cancellation signal by the cancellation signal generation section 24 based on the gain of the amplifier 33 of which the amplification factor is variably controlled by the AGC section 42. Specifically, the signal generation control section 43 changes the phase shift amount φ and the attenuation factor α used when generating the cancellation signal so that the gain becomes a maximum. Therefore, a cancellation signal that causes an interference wave included in the received signal to be removed to the maximum extent is generated so that appropriate noise cancellation is implemented.

Modification

Embodiments to which the invention may be applied are not limited to the above-described embodiments. Various modifications and variations may be made without departing from the spirit and scope of the invention.

(A) AGC

The above embodiments have been described taking an example in which the CPU 41 includes the AGC section 42 and controls the amplification factor of the amplifier 33 by means of software. Note that the amplification factor of the amplifier 33 may be controlled by means of hardware.

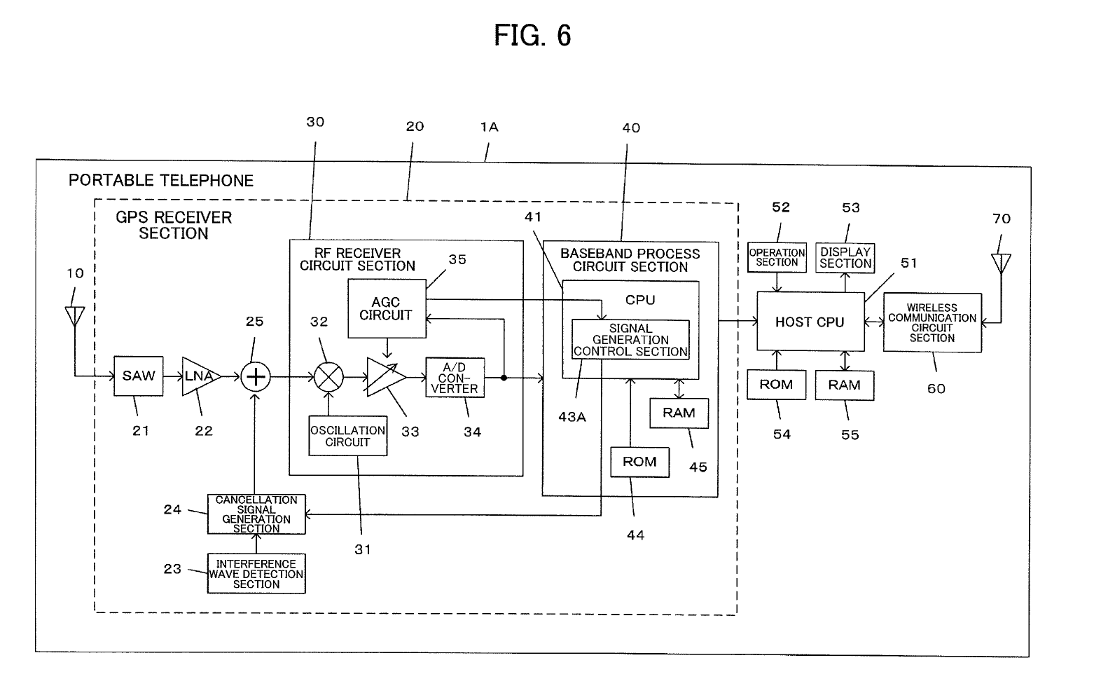

FIG. 6 is a view showing the internal configuration of a portable telephone 1A in this case. In FIG. 6, the same elements as in FIG. 1 are indicated by the same symbols. In the portable telephone 1A shown in FIG. 6, an RF receiver circuit section 30A includes the oscillation circuit 31, the mixer 32, the amplifier 33, the A/D converter 34, and an AGC circuit 35.

The AGC circuit 35 controls the amplification factor of the amplifier 33 based on the IF signal digitally converted by the A/D converter 34. Specifically, the AGC circuit 35 controls the amplification factor of the amplifier 33 so that the ratio of the signal value of each digital signal converted by the A/D converter 34 satisfies a given ratio condition in the same manner as the AGC section 42. The signal generation control section 43A generates the cancellation control signal that controls the phase shift amount φ and the attenuation factor α used when the cancellation signal generation section 24 generates the cancellation signal so that the gain calculated by the AGC circuit 35 becomes a maximum.

(B) Detection of Interference Signal

The above embodiments have been described taking an example in which the interference wave detection section 23 detects noise near the receiver section. Note that the interference wave detection section 23 may not be provided. Specifically, the cancellation signal is generated while regarding a signal transmitted and received through the antenna 70 as the interference signal.

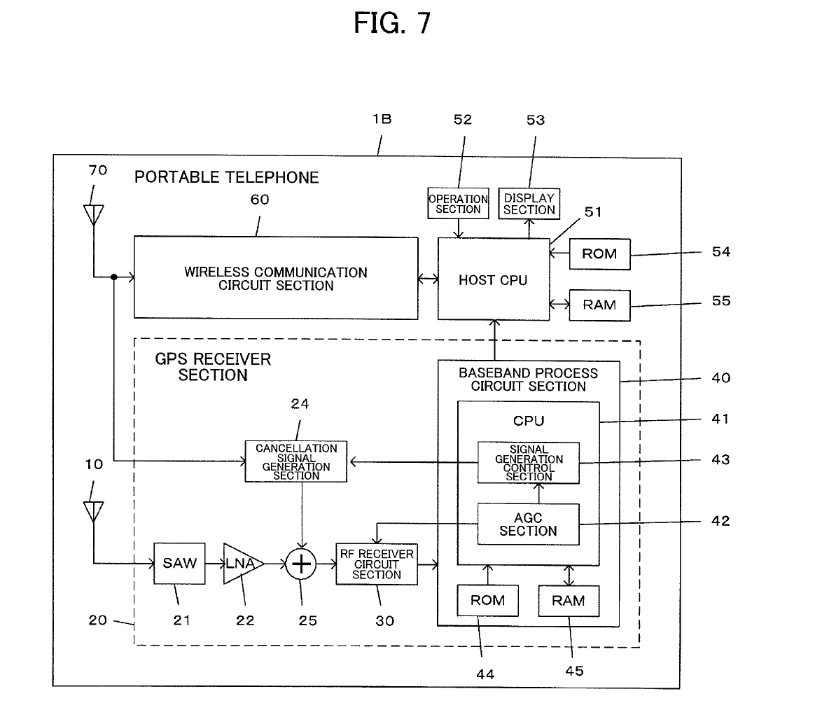

FIG. 7 is a view showing the internal configuration of a portable telephone 1B in this case. In FIG. 7, the same elements as in FIG. 1 are indicated by the same symbols. In the portable telephone 1B shown in FIG. 7, a signal transmitted and received through the antenna 70 is input to the wireless communication circuit section 60 and the cancellation signal generation section 24. The cancellation signal generation section 24 generates the cancellation signal while regarding the input signal as the interference signal.

(C) Electronic Instrument

The above embodiments have been described taking the portable telephone having a GPS function as an example. Note that the invention may also be applied to other electronic instruments such as a portable navigation system, a car navigation system, a personal digital assistant (PDA), and a wristwatch.

(D) Satellite Positioning System

The above embodiments have been described taking the case of utilizing the GPS. Note that the invention may also be applied to other satellite positioning systems such as the global navigation satellite system (GLONASS).

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A noise cancellation method comprising:
inputting an interference wave signal detected near a receiver, and changing the phase and the amplitude of the input signal to generate a cancellation signal that cancels the input signal;
adding the cancellation signal to a received signal received by the receiver, amplifying the resulting signal by a given amplification factor, and converting the amplified signal into a digital signal;
controlling the amplification factor based on a frequency ratio of each signal value of the digital signal; and
controlling amounts by which the phase and the amplitude of the input signal are changed, based on the amplification factor.

2. The noise cancellation method as defined in claim 1,
the method further including performing a search process that searches for a phase shift amount and an amplitude change rate that maximize the amplification factor by controlling the amplification factor while changing the phase shift amount and the amplitude change rate of the input signal to obtain the phase shift amount and the amplitude change rate of the input signal used when generating the cancellation signal.

3. The noise cancellation method as defined in claim 2,
the search process including setting an amplification factor change allowable range including an amplification factor equal to the amplification factor when the amplification factor has become a maximum by controlling the amplification factor; and the method further including performing an adjustment process that adjusts the phase shift amount and the amplitude change rate of the input signal used when generating the cancellation signal so that the amplification factor is included within the amplification factor change allowable range by controlling the amplification factor after the search process.

4. The noise cancellation method as defined in claim 3,
the method further including resetting the amplification factor change allowable range based on the amplification factor changed by controlling the amplification factor during the adjustment process.

5. The noise cancellation method as defined in claim 3, the phase shift amount and the amplitude change rate of the input signal being changed in the adjustment process by amounts smaller than those of the search process.

6. The noise cancellation method as defined in claim 1,
the received signal being a positioning satellite signal received by the receiver from a positioning satellite; and
the converting of the amplified signal into the digital signal including converting the amplified signal into a digital signal for a positioning calculation circuit that performs positioning calculations using the positioning satellite signal.

7. A receiver circuit comprising:
a cancellation signal generator, an interference wave signal detected near a receiver being input to the cancellation signal generator, the cancellation signal generator changing the phase and the amplitude of the input signal to generate a cancellation signal that cancels the input signal;
an addition section that adds the cancellation signal to a received signal received by the receiver;
an RF receiver circuit that amplifies the signal obtained by the addition section by a given amplification factor, and converts the amplified signal into a digital signal;
an automatic gain controller (AGC) that controls the amplification factor based on a frequency ratio of each signal value of the digital signal; and
a cancellation signal generation controller that controls a phase shift amount and an amplitude change rate of the input signal employed by the cancellation signal generator based on the amplification factor.

8. The receiver circuit as defined in claim 7,
the cancellation signal generation controller performing a search process that searches for a phase shift amount and an amplitude change rate that maximize the amplification factor controlled by the AGC while changing the phase shift amount and the amplitude change rate of the input signal employed by the cancellation signal generator to obtain the phase shift amount and the amplitude change rate of the input signal employed by the cancellation signal generator.

9. The receiver circuit as defined in claim 8,
the cancellation signal generation controller setting an amplification factor change allowable range including an amplification factor equal to the amplification factor when the amplification factor controlled by the AGC has become a maximum during the search process, and performing an adjustment process that adjusts the phase shift amount and the amplitude change rate of the input signal employed by the cancellation signal generator so that the amplification factor controlled by the AGC is included within the amplification factor change allowable range after the search process.

10. An electronic instrument comprising the receiver circuit as defined in claim 7.
